(19) United States
(12) Patent Application Publication
(10) Pub. No.: US 2026/0277806 A1
(43) Pub. Date: Sep. 17, 2026

(54) DYNAMIC CONTROL OF CACHE MODE

(71) Applicant: Google LLC, Mountain View, CA (US)

(72) Inventors: Vincent Bernard Palomares, Seattle, WA (US); Yanru Li, San Diego, CA (US); Olivier Maurice Marcel Cozette, San Francisco, CA (US); Sunitha R. Kosireddy, Saratoga, CA (US); Wei Wang, Palo Alto, CA (US)

(21) Appl. No.: 19/166,689

(22) PCT Filed: Mar. 22, 2023
(86) PCT No.: PCT/US2023/015908

§ 371 Date: Sep. 18, 2025

(51) Int. Cl. G06F 12/0802

(52) U.S. Cl. CPC G06F 12/0802; G06F 2212/60

(57) ABSTRACT

Methods, systems, and apparatus, including computer programs encoded on computer storage media, for dynamically selecting a cache mode. One of the methods includes operating a system-level cache (SLC) in a victim cache mode by implementing a portion of the SLC as a victim cache partition for a first cache. The method further includes monitoring a performance metric for the victim cache partition. When the performance metric meets one or more switching criteria, the first cache and the SLC are operated in a normal cache mode.

### BACKGROUND

This specification relates to caching.

A system on a chip (SoC) is an integrated circuit that integrates different components of a mobile computing device, including a central processing unit (CPU), memory, input/output ports, cellular radios, and secondary storage, and so on. In contrast to the traditional motherboard-based PC architecture, where a motherboard houses and connects detachable or replaceable components, SoCs integrate all these components into a single integrated circuit. SoCs are commonly used in mobile computing, edge computing, and embedded systems, such as smartphones, tablet computers, WiFi routers, Internet of Things (IOT) devices, and so on.

A memory hierarchy can allow faster access to data in memory by storing recently used data in intermediate levels of caches. A victim cache can improve performance of the memory hierarchy by storing data that gets evicted from a cache at a higher level in the hierarchy than the victim cache. For example, in a memory hierarchy with a non-victim cache, in the case of a cache miss at a higher level cache than the non-victim cache, the requested block of data is brought into the higher level cache, and the block that is evicted from the higher level cache is discarded. In a memory hierarchy with a victim cache, in the case of a cache miss at a higher level cache than the victim cache, the requested block of data is brought into the higher level cache, and the block that is evicted from the higher level cache to make room for the requested block of data is stored in the victim cache. If the evicted block of data is needed in a future memory request, the evicted block can be found in the victim cache. In some implementations, after the evicted block is brought into the higher level cache, the evicted block can be discarded from the victim cache. Accessing the victim cache from the higher level cache is faster than accessing lower levels of the memory hierarchy, which benefits power and performance.

However, in some cases the use of a victim cache can negatively impact power and performance. The overhead of maintaining a victim cache is not negligible as blocks of data are sent from the higher level cache to the victim cache. For example, a cache that is shared among client devices may adjust the size allocated to each client device partition. In cases where the partition for the victim cache is not large enough to store evicted blocks of data from the higher level cache, the evicted blocks will be discarded by the victim cache partition. Because the evicted blocks are not stored by the victim cache partition, there is no benefit to sending the evicted blocks of data to the victim cache partition.

### SUMMARY

This specification describes a system that can dynamically select a cache mode. The system operates a system-level cache (SLC) in victim cache mode by implementing a portion of the SLC as a victim cache partition for a client device cache. The system monitors a performance metric for the victim cache partition, and if the performance metric meets one or more switching criteria, the system operates the client device cache and the SLC in normal cache mode. When the system is in normal cache mode, the system monitors a performance metric for the victim cache partition, and if the performance metric meets one or more switching criteria, the system operates the client device cache and the SLC in victim cache mode.

Particular embodiments of the subject matter described in this specification can be implemented so as to realize one or more of the following advantages.

The system can improve performance at runtime by switching cache modes in order to improve system performance. For example, the system can switch from a victim cache mode to a normal cache mode. The system can determine to switch cache modes according to any appropriate performance metric, e.g., when a metric that measures the overhead of maintaining the victim cache partition satisfies a threshold. For example, in applications such as streaming video or audio where the hit rate of the victim cache partition may be close to zero, or where the victim cache partition is not large enough to store more evicted lines, the higher level cache may evict and send clean cache lines to the victim cache partition without gaining any benefit from the victim cache partition.

The system can disable victim cache mode at runtime and thus reduce the overhead by monitoring a performance metric such as a size of the SLC available for use by the victim cache partition or a hit rate for the victim cache partition, and determining if the performance metric meets one or more switching criteria. Disabling victim cache mode can also reduce the amount of power consumed in sending cache lines to the victim cache partition, which can be especially important for mobile devices.

The system can improve performance and power at runtime by re-enabling victim cache mode when the system determines that the metric that measures the overhead of maintaining a victim cache partition satisfies a threshold.

The system can maintain data coherency and limit the impact on system traffic while switching from victim cache mode to normal cache mode, and from normal cache mode to victim cache mode. For example, after the system determines that the metric that measures the overhead of maintaining a victim cache partition satisfies a threshold, and thus determines to switch modes, there may still be outstanding memory requests to the SLC that were sent before the determination to switch but are still propagating through the memory hierarchy and should thus be performed in the original cache mode. The system can use a trigger signal and a count of outstanding memory requests to ensure that outstanding memory requests are completed in the mode that the sender of the memory request intended. Thus the system can switch between modes in a coordinated fashion.

The system can maintain the same level of performance using a smaller cache that switches cache modes, as a system with a larger cache that does not switch cache modes. The system can also achieve better performance using a cache that switches cache modes than a system with a cache of the same size that does not switch cache modes. For example, the system can improve performance or maintain performance by switching cache modes at runtime.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example system for dynamically controlling cache mode.

FIG. 2 is a flowchart of an example process for switching from victim cache mode to normal cache mode.

FIGS. 3A-3B are flowcharts of an example process for dynamically switching cache mode from victim cache mode to normal cache mode.

FIG. 4 is a flowchart of an example process for dynamically switching cache mode from normal cache mode to victim cache mode.

Like reference numbers and designations in the various drawings indicate like elements.

### DETAILED DESCRIPTION

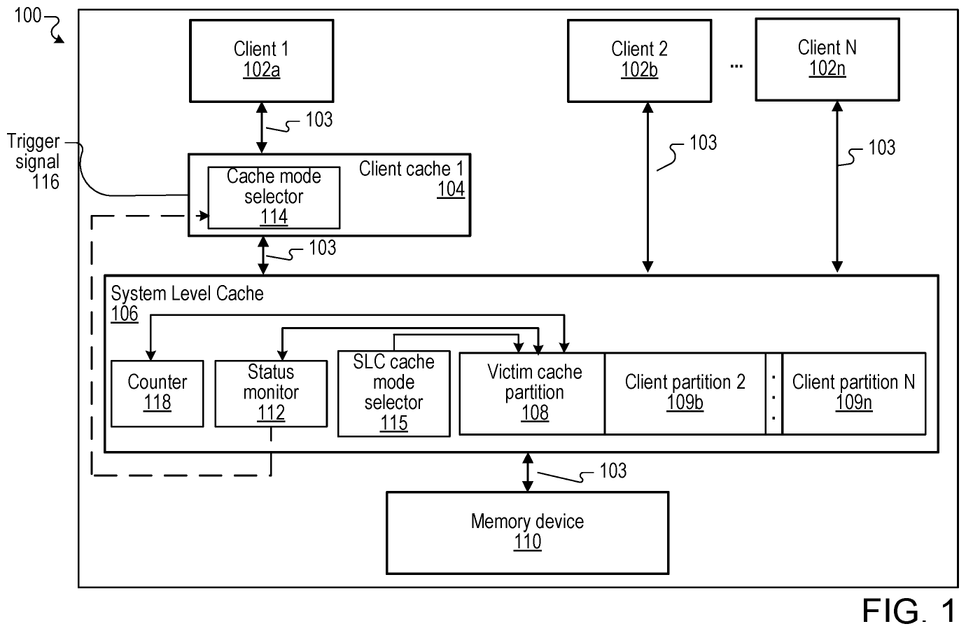

FIG. 1 is a block diagram of an example system 100 for dynamically controlling cache mode. The system 100 includes various components, such as client devices 102a-102n (collectively, “client devices 102”), a first cache 104, a system level cache (SLC) 106, and a memory device 110.

A system-level cache (SLC) is any appropriate device that caches data retrieved from memory or data to be stored to memory for multiple different hardware devices in a system. In other words, different cache lines of the SLC can store data belonging to different hardware devices, e.g., different processors, central processing units (CPUs), graphics processing units (GPUs), digital signal processors (DSPs), microcontrollers, machine learning accelerators, or image processors, to name just a few examples. As shown in FIG. 1, an SLC can be a part of a larger cache hierarchy. For some hardware devices, one or more additional cache levels may exist between the hardware device and the SLC. Other hardware devices may use the SLC directly without an intervening cache level.

A cache that is higher in the cache hierarchy is closer to the different hardware devices, i.e., there are fewer cache levels in between the cache and the hardware device than a cache that is lower in the cache hierarchy. A cache that is lower in the cache hierarchy is closer to memory, i.e., there are fewer cache levels in between the cache and memory than a cache that is higher in the cache hierarchy.

A client device of client devices 102a-102n can be any type of hardware device that is configured to provide memory requests 103 through the SLC 106 to the memory device 110, such as a central processing unit (CPU), a digital signal processor (DSP), a neural processing unit (NPU), or a cache.

Each client device 102a-102n can have a cache that is higher in a cache hierarchy than the SLC 106. In the example system 100, client 1 102a has a client cache 1 104.

The SLC 106 can be any cache that is configured to cache memory requests to the memory device 110 and can be operated in a victim cache mode by implementing a portion as a victim cache partition 108 while also serving memory requests for other client devices.

In the example system 100, the SLC 106 includes a victim cache partition 108 and partitions for clients 2-N 102b-102n, client partitions 2-N 109b-109n. An SLC is shared across client devices 102, and can adjust the partition size allocated to each client device in client partitions 109b-109n and the victim cache partition 108.

In some implementations, the SLC 106 can implement multiple portions as victim cache partitions for multiple client devices. In some implementations, the SLC 106 can include a status monitor, counter, and SLC cache mode selector for each of the victim cache partitions. For example, each of the victim cache partitions can be in its own cache mode independent of the other victim cache partitions. Each client and their corresponding client partition can decide the cache mode, whether it is victim cache mode or normal cache mode. For example, client partition 2 109b can be a victim cache partition of client 2 102b and a client cache 2 for client 2 102b (not shown), independent of whether victim cache partition 108 is actually configured to be in victim cache mode or normal cache mode. Each victim cache partition, e.g., victim cache partition 108, is viewed as an extension of its corresponding client's internal cache, e.g., client cache 1, and the visibility and data coherence can comply with the theory of operation as if the clean evicted victim cache data is located in the client's internal cache.

A memory device 110 can be any type of computing device that stores data for memory requests, such as a cache, random-access memory (RAM) or dynamic random-access memory (DRAM).

Client cache 1 104 includes a cache mode selector 114 that the system can use to control the cache mode of client cache 1 104. The cache mode selector 114 is a software or hardware entity that can control the cache mode of client cache 1 104, for example, by enabling or disabling victim cache mode for client cache 1 104. Possible cache modes can include, for example, victim cache mode (victim cache mode is enabled) or normal cache mode (victim cache mode is disabled).

In the case of a cache miss in client cache 1 104, data can be retrieved from lower levels of the memory hierarchy such as the SLC 106 or the memory device 110. The data that is retrieved from lower levels of the memory hierarchy replaces data, a victim line, in the client cache 1 104. In normal cache mode, the system silently drops the data in the clean victim line. In victim cache mode, the system stores the data from the victim line in a lower level cache, or a victim cache.

The system can implement a portion of the SLC 106 as a victim cache partition 108 for client cache 1 104. The system can use an SLC cache mode selector 115 to enable or disable victim cache mode for the victim cache partition 108. The SLC cache mode selector 115 is a software or hardware entity that can control the cache mode of the victim cache partition 108, for example, by enabling or disabling victim cache mode for the victim cache partition 108. Possible cache modes can include, for example, victim cache mode (victim cache mode is enabled) or normal cache mode (victim cache mode is disabled).

In the case of a cache miss in client cache 1 104, data can be retrieved from lower levels of the memory hierarchy such as the SLC 106 or the memory device 110. The data that is retrieved from lower levels of the memory hierarchy replaces a victim line in the client cache 1 104. In normal cache mode, the system silently drops the data in the clean victim line. In victim cache mode, the system stores the data from the victim line in the victim cache partition 108.

The system can use a status monitor 112 to monitor a performance metric for the victim cache partition 108. For example, a performance metric can include a size of the SLC 106 available for use by the victim cache partition 108. In some implementations, the performance metric can include a hit rate for the victim cache partition 108. In some implementations, the performance metric can also measure the intensity of the traffic for the victim cache partition 108, the read/write ratio for the victim cache partition 108, or an active use case for the victim cache partition 108.

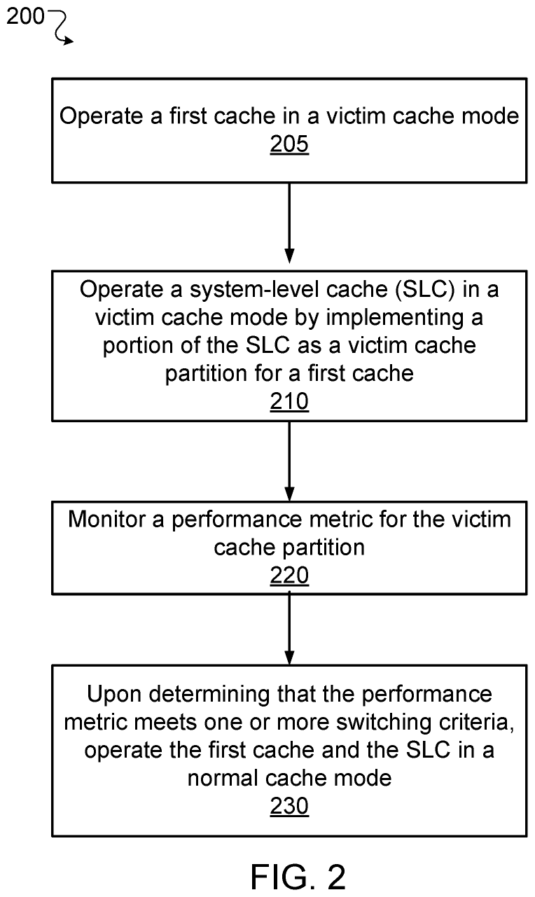

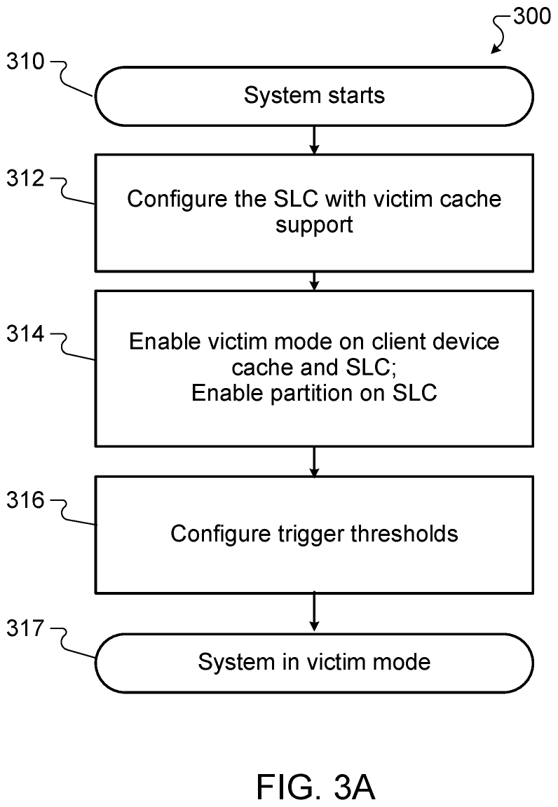

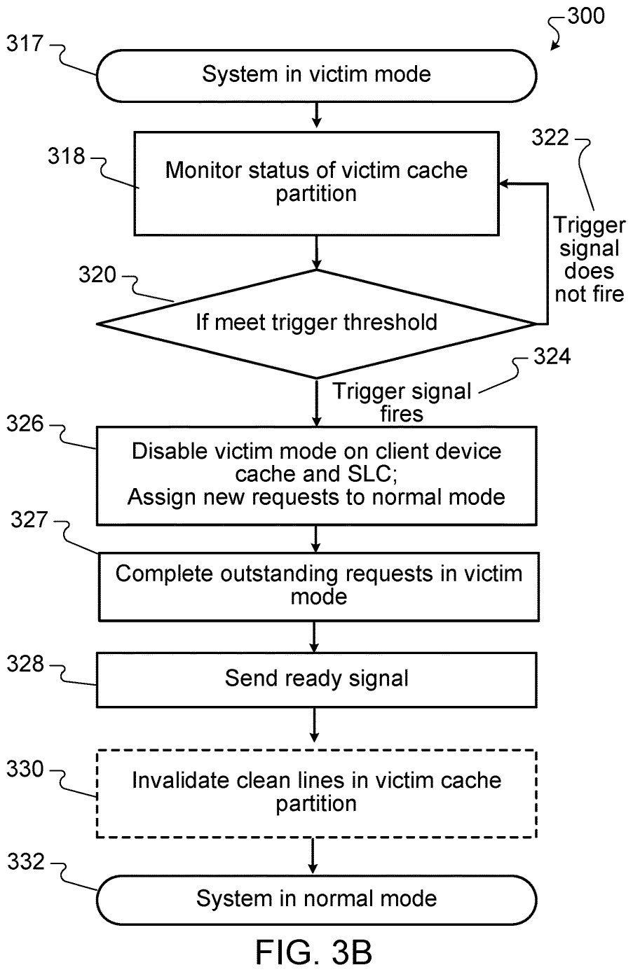

If the SLC 106 is in victim cache mode, upon determining that the performance metric meets one or more switching criteria, the system can operate the client cache 1 104 and SLC 106 in the normal cache mode instead of the victim cache mode. For example, the switching criteria can be a threshold victim cache partition size or a threshold hit rate for the victim cache partition. The system can use the status monitor 112 to send a trigger signal 116 to trigger the process to switch from victim cache mode to normal cache mode. To maintain data coherency when switching from victim cache mode to normal cache mode, the system can use a counter 118 to maintain a count of outstanding memory requests that were made to the SLC before the trigger signal fired but have not yet been served by the SLC. The switching process will be described in more detail below with reference to FIGS. 2 and 3.

If the SLC 106 is operating in the normal cache mode, the system can store cache data from clients 2-N 102b-102n in victim cache partition 108 (the portion of the SLC 106 that served as an exclusive victim cache partition for client cache 1 104 when the SLC 106 was operated in the victim cache mode).

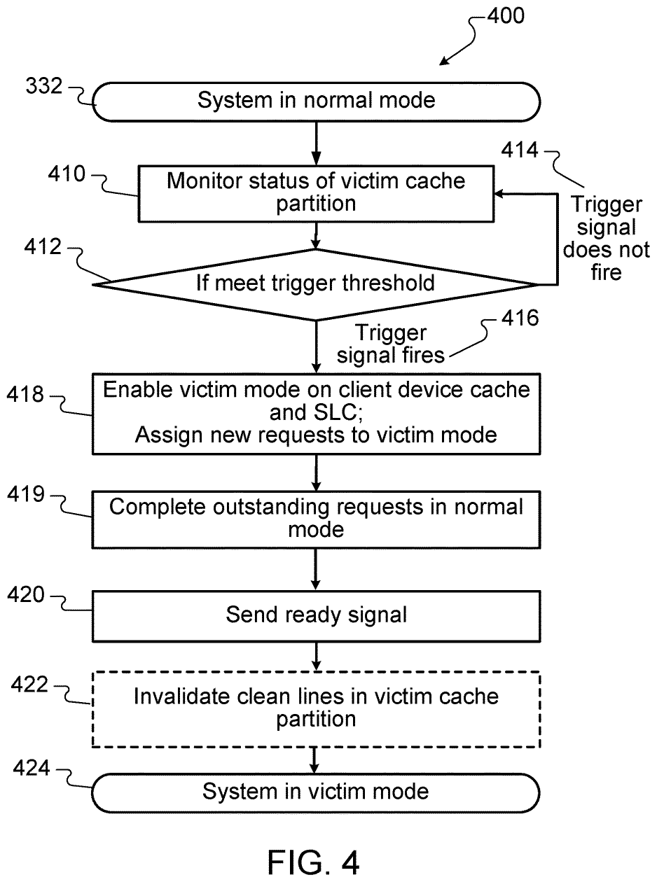

If the SLC 106 is in normal cache mode, upon determining that the performance metric meets one or more switching criteria, the system can operate the client cache 1 104 and SLC 106 in the victim cache mode instead of the normal cache mode. For example, the switching criteria can be a threshold victim cache partition size or a threshold hit rate for the victim cache partition. The system can use the status monitor 112 to send a trigger signal 116 to trigger the process to switch from normal cache mode to victim cache mode. To maintain data coherency when switching from normal cache mode to victim cache mode, the system can use a counter 118 to maintain a count of outstanding memory requests that were made to the SLC before the trigger signal fired but have not yet been served by the SLC. The switching process will be described in more detail below with reference to FIG. 4.

FIG. 2 is a flowchart of an example process 200 for switching from victim cache mode to normal cache mode. The process 200 can be performed by any appropriate system, e.g., the system 100 of FIG. 1.

The system can operate a first cache, e.g., client cache 1 104 of FIG. 1, in a victim cache mode (205). For example, the system can enable victim cache mode on the first cache using a cache mode selector, e.g., the cache mode selector 114 of FIG. 1, of the first cache.

The system can operate an SLC in a victim cache mode by implementing a portion of the SLC as a victim cache partition for the first cache (210). The SLC can also serve memory requests for other client devices, e.g., clients 2-N 102b-102n of FIG. 1. The SLC operating in the victim cache mode can store data from a victim line of a cache miss of the first cache in the victim cache partition.

The system can monitor a performance metric for the victim cache partition (220). In some implementations, the performance metric can include a size of the SLC available for use by the victim cache partition. In some implementations, the performance metric can include a hit rate for the victim cache partition.

Upon determining that the performance metric meets one or more switching criteria, the system can operate the first cache and the SLC in a normal cache mode (230). The SLC operating in the normal cache mode can drop data from a victim line of a cache miss of the first cache.

In implementations where the performance metric includes a size of the SLC available for use by the victim partition, determining that the performance metric meets one or more switching criteria can include comparing the size of the SLC available for use by the victim cache partition with a threshold victim cache partition size. In implementations where the performance metric includes a hit rate for the victim cache partition, determining that the performance metric meets one or more switching criteria can include comparing the hit rate for the victim cache partition with a threshold hit rate for the victim cache partition.

In some implementations, the switching criteria can be a software programmable parameter. In some implementations, the switching criteria can be defined at design time. The system can operate the first cache and the SLC in a normal cache mode by using a trigger signal. The trigger signal will be described in more detail below with reference to FIG. 3B.

FIGS. 3A-3B are flowcharts of an example process 300 for dynamically switching cache mode from victim cache mode to normal cache mode. The process 300 can be performed by any appropriate system, e.g., the system 100 of FIG. 1.

FIG. 3A shows how the system can be initially configured to enable dynamically switching cache mode from victim cache mode to normal cache mode. For example, when the system starts, the system can be configured in victim cache mode. The system can perform the steps in FIG. 3B to dynamically switch cache mode from victim cache mode to normal cache mode. In some implementations, when the system starts, the system can be configured in normal cache mode and perform the steps in FIG. 4 to dynamically switch cache mode from normal cache mode to victim cache mode.

After the system starts (310), the system configures the SLC with victim cache support (312). Configuring the SLC with victim cache support can include implementing a portion of the SLC as a victim cache partition for a client device cache, for example, client cache 1 104 of FIG. 1. It is important that both the SLC and the client device caches are in agreement on the cache mode. In some implementations, for example, configuring the SLC with victim cache support can include reading and writing values into registers, or other interactions between components of the SLC.

The system enables victim cache mode on the client device cache and the SLC, and enables the partition on the SLC as a victim cache partition (314). The SLC operating in the victim cache mode can store data from a victim line of a cache miss of the client device cache in the victim cache partition. The system can enable victim cache mode on the client device cache using a cache mode selector, e.g., the cache mode selector 114 of FIG. 1, of the client device cache. For example, the system can enable the writing back of evicted clean cache lines. The system can enable the partition on the SLC as a victim cache partition using an SLC cache mode selector, e.g., the SLC cache mode selector 115 of FIG. 1. For example, clean cache lines that are written back by the client device cache can be stored in the victim cache partition. The system can also invalidate cache lines that are read by the client device cache from the victim cache partition.

The system configures trigger thresholds (316). For example, a trigger threshold can be a threshold victim cache partition size or a threshold hit rate for the victim cache partition. The system can use the trigger thresholds to define the switching criteria.

The system can now operate in victim cache mode (317). The SLC operating in the victim cache mode can store data from a victim line of a cache miss of the client device cache in the victim cache partition. The system can perform the steps of FIG. 3B to dynamically switch cache mode from victim cache mode to normal cache mode.

FIG. 3B shows how the system can dynamically switch cache mode from victim cache mode to normal cache mode. The system is in victim cache mode (317) as described above with reference to FIG. 3A.

The system monitors the status of the victim cache partition (318). The system can monitor a performance metric that describes the status of the victim cache partition. For example, the system can monitor a size of the SLC available for use by the victim cache partition or a hit rate for the victim cache partition. In some implementations, the system can monitor the intensity of the traffic for the victim cache partition, the read/write ratio for the victim cache partition, or an active use case for the victim cache partition.

If the system determines that the trigger threshold is not met (320), the trigger signal does not fire (322), and the system continues to monitor the status of the victim cache partition (318). For example, if the system compares the size of the SLC available for use by the victim cache partition with the threshold victim cache partition size and determines that the size of the SLC available for use by the victim cache partition is greater than the threshold victim cache partition size, the trigger signal will not fire.

If the system determines that the trigger threshold is met (320), the trigger signal fires (324). For example, if the system compares the size of the SLC available for use by the victim cache partition with the threshold victim cache partition size and determines that the size of the SLC available for use by the victim cache partition is less than or equal to the threshold victim cache partition size, the trigger signal will fire.

The system disables victim cache mode on the client device cache and the SLC (326). The system can disable victim cache mode on the client device cache using a cache mode selector, e.g., the cache mode selector 114 of FIG. 1, of the client device cache. For example, the system can disable the writing back of evicted clean cache lines. The system can disable the partition on the SLC as a victim cache partition using an SLC cache mode selector, e.g., the SLC cache mode selector 115 of FIG. 1. The system assigns new memory requests to the normal cache mode (326).

The system completes outstanding memory requests in victim cache mode (327). For example, the system can maintain a count of outstanding memory requests that were made to the SLC before the trigger signal fired but have not yet been served by the SLC. The system can subtract from the count of outstanding memory requests upon completing each outstanding memory request in victim cache mode.

Upon determining that the count of outstanding memory requests is zero, the system can send a ready signal to the SLC (328). The ready signal represents that the system has completed the outstanding memory requests in victim cache mode.

In some implementations, the system invalidates clean cache lines in the victim cache partition (330). The system can also make the cache lines in the victim cache partition available to other client devices. That is, the system configures the SLC to store cache data from other client devices in the portion of the SLC that served as the exclusive victim cache partition for the client device cache when victim cache mode was enabled on the SLC. In some implementations, for example, the SLC removes an indication that a clean evicted line can only be hit by the transactions within the coherence domain. In some implementations, the system can use protocols such as snooping to maintain data coherency.

For dirty cache lines from the client device cache, the system can maintain data coherency. The system may remove the indication that the dirty line belongs to a particular victim cache partition.

The system can now operate in normal cache mode (332). The SLC operating in the normal cache mode can drop data from a victim line of a cache miss of the client device cache. The system can perform the steps of FIG. 4 to dynamically switch cache mode from normal cache mode to victim cache mode.

FIG. 4 is a flowchart of an example process 400 for dynamically switching cache mode from normal cache mode to victim cache mode. The process 300 can be performed by any appropriate system, e.g., the system 100 of FIG. 1.

The system is in normal cache mode (332) as described above with reference to FIG. 3B. Victim cache mode for the client device cache and the SLC is disabled, but the victim cache partition is enabled. The victim cache partition is not being used as a victim cache. The system has already configured the thresholds as described above with reference to step 316 of FIG. 3A.

The system monitors the status of the victim cache partition (410). For example, the system can monitor a size of the SLC available for use by the victim cache partition or a hit rate for the victim cache partition. In some implementations, the system can monitor the intensity of the traffic for the victim cache partition, the read/write ratio for the victim cache partition, or an active use case for the victim cache partition.

If the system determines that the trigger threshold is not met (412), the trigger signal does not fire (414), and the system continues to monitor the status of the victim cache partition (410). For example, if the system compares the size of the SLC available for use by the victim cache partition with the threshold victim cache partition size and determines that the size of the SLC available for use by the victim cache partition is less than or equal to the threshold victim cache partition size, the trigger signal will not fire.

If the system determines that the trigger threshold is met (412), the trigger signal fires (416). For example, if the system compares the size of the SLC available for use by the victim cache partition with the threshold victim cache partition size and determines that the size of the SLC available for use by the victim cache partition is greater than the threshold victim cache partition size, the trigger signal will fire.

The system enables victim cache mode on the client device cache and the SLC (418). The system can enable victim cache mode on the client device cache using a cache mode selector, e.g., the cache mode selector 114 of FIG. 1, of the client device cache. For example, the system can enable the writing back of evicted clean cache lines. The system can enable the partition on the SLC as a victim cache partition using an SLC cache mode selector, e.g., the SLC cache mode selector 115 of FIG. 1. The system assigns new memory requests to the victim cache mode (418).

The system completes outstanding memory requests in normal cache mode (419). For example, the system can maintain a count of outstanding memory requests that were made to the SLC before the trigger signal fired but have not yet been served by the SLC. The system can subtract from the count of outstanding memory requests upon completing each outstanding memory request.

Upon determining that the count of outstanding memory requests is zero, the system can send a ready signal to the SLC (420). The ready signal represents that the system has completed the outstanding memory requests in normal cache mode.

In some implementations, the system invalidates clean cache lines in the victim cache partition (422). Invalidating clean cache lines allows the system to use the victim cache partition to store other data.

The system can now operate in victim cache mode (424). The SLC operating in the victim cache mode can store data from a victim line of a cache miss of the client device cache in the victim cache partition. The system can perform the steps 318 to 332 of FIG. 3B to dynamically switch cache mode from victim cache mode to normal cache mode.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them.

Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

In addition to the embodiments described above, the following embodiments are also innovative:

Embodiment 1 is a system comprising:
a memory device;
a system-level cache (SLC) configured to cache memory requests to the memory device;
a plurality of client devices configured to provide memory requests through the SLC to the memory device, wherein a first client device has a first cache that is higher in a cache hierarchy than the SLC, wherein the system is configured to operate the first cache in a victim cache mode,
wherein the system is configured to operate the SLC in a victim cache mode by implementing a portion of the SLC as a victim cache partition for the first cache while also serving memory requests for other client devices of the plurality of other client devices,
and wherein the system is configured to monitor a performance metric for the victim cache partition and, upon determining that the performance metric meets one or more switching criteria, to operate the first cache and the SLC in a normal cache mode instead of the victim cache mode.

Embodiment 2 is the system of claim 1, wherein operating the SLC in the victim cache mode comprises storing data from a victim line of a cache miss of the first cache in the victim cache partition of the SLC.

Embodiment 3 is the system of any one of embodiments 1-2, wherein operating the SLC in the normal cache mode comprises dropping data from a victim line of a cache miss of the first cache.

Embodiment 4 is the system of any one of embodiments 1-3, wherein operating the SLC in the normal cache mode comprises storing cache data from other client devices in a portion of the SLC that serves as an exclusive victim cache partition for the first cache when the SLC is operated in the victim cache mode.

Embodiment 5 is the system of any one of embodiments 1-4, wherein the performance metric comprises a size of the SLC available for use by the victim cache partition, and wherein determining that the performance metric meets one or more switching criteria comprises comparing the size of the SLC available for use by the victim cache partition with a threshold victim cache partition size.

Embodiment 6 is the system of any one of embodiments 1-5, wherein the performance metric comprises a hit rate for the victim cache partition, and wherein determining that the performance metric meets one or more switching criteria comprises comparing the hit rate for the victim cache partition with a threshold hit rate for the victim cache partition.

Embodiment 7 is the system of any one of embodiments 1-6, wherein the system is configured to use a trigger signal to operate the first cache and the SLC in the normal cache mode instead of the victim cache mode.

Embodiment 8 is the system of embodiment 7, wherein the system is configured to maintain a count of outstanding memory requests in the victim cache mode, wherein an outstanding memory request is a memory request made to the SLC before the trigger signal but not yet served by the SLC.

Embodiment 9 is the system of embodiment 8, wherein the system is configured to subtract from the count of outstanding memory requests upon completing an outstanding memory request, and upon determining that the count is zero, operating the first cache and the SLC in the normal cache mode.

Embodiment 10 is the system of embodiment 9, wherein upon determining that the count is zero, the system is configured to clear clean cache lines in the victim cache partition.

Embodiment 11 is the system of any one of embodiments 1-6, wherein the system is configured to operate the SLC and the first cache in a normal cache mode, and wherein the system is configured to monitor a performance metric for the victim cache partition and, upon determining that the performance metric meets one or more switching criteria, to operate the first cache and the SLC in the victim cache mode instead of the normal cache mode.

Embodiment 12 is the system of embodiment 11, wherein the system is configured to use a trigger signal to operate the first cache and the SLC in the victim cache mode instead of the normal cache mode.

Embodiment 13 is the system of embodiment 12, wherein the system is configured to maintain a count of outstanding memory requests in the normal cache mode, wherein an outstanding memory request is a memory request made to the SLC before the trigger signal but not yet served by the SLC.

Embodiment 14 is the system of embodiment 13, wherein the system is configured to subtract from the count of outstanding memory requests upon completing an outstanding memory request, and upon determining that the count is zero, operating the first cache and the SLC in the victim cache mode.

Embodiment 15 is the system of embodiment 14, wherein upon determining that the count is zero, the system is configured to clear clean cache lines in the victim cache partition.

Embodiment 16 is a method performed by a system comprising:
a memory device;
a system-level cache (SLC) configured to cache memory requests to the memory device; and
a plurality of client devices configured to provide memory requests through the SLC to the memory device;
the method comprising:
   operating the SLC in a victim cache mode by implementing a portion of the SLC as a victim cache partition for the first cache while also serving memory requests for other client devices of the plurality of other client devices;
   monitoring a performance metric for the victim cache partition; and
   upon determining that the performance metric meets one or more switching criteria, operating the first cache and the SLC in a normal cache mode instead of the victim cache mode.

Embodiment 17 is the method of embodiment 16, wherein operating the SLC in the victim cache mode comprises storing data from a victim line of a cache miss of the first cache in the victim cache partition of the SLC.

Embodiment 18 is the method of any one of embodiments 16-17, wherein operating the SLC in the normal cache mode comprises dropping data from a victim line of a cache miss of the first cache.

Embodiment 19 is the method of any one of embodiments 16-18, wherein operating the SLC in the normal cache mode comprises storing cache data from other client devices in a portion of the SLC that serves as an exclusive victim cache partition for the first cache when the SLC is operated in the victim cache mode.

Embodiment 20 is the method of any one of embodiments 16-19, wherein the performance metric comprises a size of the SLC available for use by the victim cache partition, and wherein determining that the performance metric meets one or more switching criteria comprises comparing the size of the SLC available for use by the victim cache partition with a threshold victim cache partition size.

Embodiment 21 is the method of any one of embodiments 16-20, wherein the performance metric comprises a hit rate for the victim cache partition, and wherein determining that the performance metric meets one or more switching criteria comprises comparing the hit rate for the victim cache partition with a threshold hit rate for the victim cache partition.

Embodiment 22 is the method of any one of embodiments 16-21, wherein operating the first cache and the SLC in the normal cache mode instead of the victim cache mode comprises using a trigger signal.

Embodiment 23 is the method of embodiment 22, wherein the method further comprises:
maintaining a count of outstanding memory requests in the victim cache mode, wherein an outstanding memory request is a memory request made to the SLC before the trigger signal but not yet served by the SLC.

Embodiment 24 is the method of embodiment 23, wherein the method further comprises:
subtracting from the count of outstanding memory requests upon completing an outstanding memory request; and
upon determining that the count is zero, operating the first cache and the SLC in the normal cache mode.

Embodiment 25 is the method of embodiment 24, wherein upon determining that the count is zero, the method further comprises clearing clean cache lines in the victim cache partition.

Embodiment 26 is the method of any one of embodiments 16-21, wherein method further comprises:
operating the SLC and the first cache in a normal cache mode;
monitoring a performance metric for the victim cache partition; and
upon determining that the performance metric meets one or more switching criteria, operating the first cache and the SLC in the victim cache mode instead of the normal cache mode.

Embodiment 27 is the method of embodiment 26, wherein operating the first cache and the SLC in the victim cache mode instead of the normal cache mode comprises use a trigger signal.

Embodiment 28 is the method of embodiment 27, wherein the method further comprises:
maintaining a count of outstanding memory requests in the normal cache mode, wherein an outstanding memory request is a memory request made to the SLC before the trigger signal but not yet served by the SLC.

Embodiment 29 is the method of embodiment 28, wherein the method further comprises:
subtracting from the count of outstanding memory requests upon completing an outstanding memory request; and
upon determining that the count is zero, operating the first cache and the SLC in the victim cache mode.

Embodiment 30 is the method of embodiment 29, wherein upon determining that the count is zero, the method further comprises clearing clean cache lines in the victim cache partition.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A system comprising:
a memory device;
a system-level cache (SLC) configured to cache memory requests to the memory device;
a plurality of client devices configured to provide memory requests through the SLC to the memory device, wherein a first client device has a first cache that is higher in a cache hierarchy than the SLC, wherein the system is configured to operate the first cache in a victim cache mode,
wherein the system is configured to operate the SLC in a victim cache mode by implementing a portion of the SLC as a victim cache partition for the first cache while also serving memory requests for other client devices of the plurality of other client devices,
and wherein the system is configured to monitor a performance metric for the victim cache partition and, upon determining that the performance metric meets one or more switching criteria, to operate the first cache and the SLC in a normal cache mode instead of the victim cache mode.

2. The system of claim 1, wherein operating the SLC in the victim cache mode comprises storing data from a victim line of a cache miss of the first cache in the victim cache partition of the SLC.

3. The system of claim 1, wherein operating the SLC in the normal cache mode comprises dropping data from a victim line of a cache miss of the first cache.

4. The system of claim 1, wherein operating the SLC in the normal cache mode comprises storing cache data from other client devices in a portion of the SLC that serves as an exclusive victim cache partition for the first cache when the SLC is operated in the victim cache mode.

5. The system of claim 1, wherein the performance metric comprises a size of the SLC available for use by the victim cache partition, and wherein determining that the performance metric meets one or more switching criteria comprises comparing the size of the SLC available for use by the victim cache partition with a threshold victim cache partition size.

6. The system of claim 1, wherein the performance metric comprises a hit rate for the victim cache partition, and wherein determining that the performance metric meets one or more switching criteria comprises comparing the hit rate for the victim cache partition with a threshold hit rate for the victim cache partition.

7. The system of claim 1, wherein the system is configured to use a trigger signal to operate the first cache and the SLC in the normal cache mode instead of the victim cache mode.

8. The system of claim 7, wherein the system is configured to maintain a count of outstanding memory requests in the victim cache mode, wherein an outstanding memory request is a memory request made to the SLC before the trigger signal but not yet served by the SLC.

9. The system of claim 8, wherein the system is configured to subtract from the count of outstanding memory requests upon completing an outstanding memory request, and upon determining that the count is zero, operating the first cache and the SLC in the normal cache mode.

10. The system of claim 9, wherein upon determining that the count is zero, the system is configured to clear clean cache lines in the victim cache partition.

11. The system of claim 1, wherein the system is configured to operate the SLC and the first cache in a normal cache mode,
and wherein the system is configured to monitor a performance metric for the victim cache partition and, upon determining that the performance metric meets one or more switching criteria, to operate the first cache and the SLC in the victim cache mode instead of the normal cache mode.

12. The system of claim 11, wherein the system is configured to use a trigger signal to operate the first cache and the SLC in the victim cache mode instead of the normal cache mode.

13. The system of claim 12, wherein the system is configured to maintain a count of outstanding memory requests in the normal cache mode, wherein an outstanding memory request is a memory request made to the SLC before the trigger signal but not yet served by the SLC.

14. The system of claim 13, wherein the system is configured to subtract from the count of outstanding memory requests upon completing an outstanding memory request, and upon determining that the count is zero, operating the first cache and the SLC in the victim cache mode.

15. The system of claim 14, wherein upon determining that the count is zero, the system is configured to clear clean cache lines in the victim cache partition.

16. A method performed by a system comprising:
a memory device;
a system-level cache (SLC) configured to cache memory requests to the memory device; and
a plurality of client devices configured to provide memory requests through the SLC to the memory device;
the method comprising:
operating the SLC in a victim cache mode by implementing a portion of the SLC as a victim cache partition for the first cache while also serving memory requests for other client devices of the plurality of other client devices;
monitoring a performance metric for the victim cache partition; and
upon determining that the performance metric meets one or more switching criteria, operating the first cache and the SLC in a normal cache mode instead of the victim cache mode.

17. The method of claim 16, wherein operating the SLC in the victim cache mode comprises storing data from a victim line of a cache miss of the first cache in the victim cache partition of the SLC.

18. The method of claim 16, wherein operating the SLC in the normal cache mode comprises dropping data from a victim line of a cache miss of the first cache.

19. The method of claim 16, wherein operating the SLC in the normal cache mode comprises storing cache data from other client devices in a portion of the SLC that serves as an exclusive victim cache partition for the first cache when the SLC is operated in the victim cache mode.

20. The method of claim 16, wherein the performance metric comprises a size of the SLC available for use by the victim cache partition, and wherein determining that the performance metric meets one or more switching criteria comprises comparing the size of the SLC available for use by the victim cache partition with a threshold victim cache partition size.

21-30. (canceled)
